(19) United States
(12) Patent Application Publication
(10) Pub. No.: US 2026/0132985 A1
(43) Pub. Date: May 14, 2026

(54) A SPRAY DRYER ARRANGEMENT AND A METHOD OF CONTROLLING SUCH AN ARRANGEMENT

(71) Applicant: Munters Netherlands B.V., Moordrecht MC (NL)

(72) Inventor: Marcel Van Den Berghe, Zutphen (NL)

(21) Appl. No.: 19/111,672

(22) PCT Filed: Sep. 7, 2023
(86) PCT No.: PCT/EP2023/074681

§ 371 Date: Mar. 13, 2025

(30) Foreign Application Priority Data
Sep. 15, 2022 (SE) 2251074-7

(51) Int. Cl. F26B 21/20; F26B 21/33; F26B 21/35; F26B 23/00

(52) U.S. Cl. CPC F26B 21/20; F26B 21/333; F26B 21/35; F26B 23/005

(57) ABSTRACT

A spray dryer arrangement comprising a spray dryer device (1), a heat pump (14) and a dehumidifier device (24), a primary liquid circuit (20) and a secondary liquid circuit (22). The spray dryer arrangement comprises a bypass conduit (66) provided in the secondary liquid circuit for bypassing a second heat exchanger (23), and a controllable valve (34) for controlling a flow of secondary liquid into the bypass conduit (66) and to the second heat exchanger (23) respectively, a temperature sensor (35) for measuring the temperature of the secondary liquid in the secondary liquid circuit (22), and a control unit (36) configured to control the controllable valve (34) on basis of input from the temperature sensor (35), and configured to thereby regulate the temperature of the secondary liquid in the secondary circuit (22) to be within a predetermined temperature range.

### TECHNICAL FIELD

The present invention relates to a spray dryer arrangement comprising
a spray dryer device comprising an air inlet and an air outlet, and an inlet for introduction of material to be dried and an outlet for removal of material that has been dried in the spray dryer device,
a heat pump comprising a closed circuit in which a heat transferring medium is circulated, wherein the closed circuit comprises a compressor, an expansion valve device, an evaporator and a condenser,
a dehumidifier device comprising an air inlet and an air outlet, and a dehumidifier element for dehumidification of air introduced through the air inlet and removed through the air outlet,
a primary liquid circuit, which is connected to the closed circuit of the heat pump via heat-exchange through the condenser and which comprises a first heat exchanger configured for heat exchange between the primary liquid and air which is to be introduced into the spray drier device through the spray dryer device inlet, and
a secondary liquid circuit, which is connected to the closed circuit of the heat pump via heat exchange through the evaporator, and which comprises a second heat exchanger configured for heat exchange between the secondary liquid and air removed from the spray dryer device via the spray dryer device air outlet.

The invention also comprises a method of controlling such spray dryer arrangement.

### BACKGROUND

Spray dryer arrangements which comprises a spray dryer device connected to heat pump and a dehumidifier device are known in prior art. The heat pump is used for providing hot liquid that is used for heating air that is to be introduced into the spray dryer device for the purpose of drying wet material introduced into the same spray dryer device. The air that goes through the spray dryer device will exit the spray dryer device as relatively warm exhaust air that may have a considerable energy.

Before being heated through heat exchange with the hot liquid from the heat pump, the air that is to be introduced into the spray dryer device is dried in a dehumidifier device. The dehumidifier may be of a type that could make use of energy in the exhaust air from the spray dryer device. For example, the dehumidifier may be of a desiccant type that needs hot air for the regeneration of its dehumidifier element. Depending on the temperature of the surrounding atmosphere, the air to be introduced into the dehumidifier device may also need to be heated. The hot liquid on the hot side of the heat pump may thus be used for heating not only the air that is to be introduced into the spray dryer device, but also to heat the air that is to be introduced into the dehumidifier device, and to heat air that is used for regenerating a dehumidifier element of the dehumidifier device.

The cold side of the heat pump, which comprises a liquid, typically water, that exchanges heat with the heat transferring medium of the heat pump through the evaporator of the heat pump. Depending on the temperature of the surrounding atmosphere, the cold liquid of the cold side of the heat pump may be used for pre-cooling air that is to be introduced into the dehumidifier device.

Heat (energy) of the exhaust air from the spray dryer device may be used for the purpose of heating the cold liquid on the cold side of the heat pump before returning the latter for further heat exchange via the evaporator.

The output of the compressor of the heat pump may be controlled for the purpose of controlling the temperature of the liquid on the hot side of the heat pump and, accordingly, the temperature of the air that is to be introduced into the spray dryer device.

The balancing of the arrangement is vital for the energy efficiency thereof. It is of advantage to use only one heat pump, and that the capacity of the heat pump is as small as possible but still capable of delivering the heat needed for the spray dryer, the heating of the dehumidifier (both for regeneration and air to be introduced into the dehumidifier). The balancing also includes making the arrangement able of coping with different ambient air temperatures, for example from minus 20 degrees Celsius up to plus 50 degrees Celsius.

WO2018091049A1 discloses an arrangement similar to the one disclosed hereinabove. However, WO2018091049A1 is rather vague about how to control the arrangement and to balance it in such a way that an advantageous efficiency is achieved.

It is thus an objective of the present invention to suggest a spray dryer arrangement which is designed in a way that promotes a stable and efficient operation thereof, which is able of delivering air of predetermined temperature to a spray dryer device independent of differences in ambient air temperatures, and which, due to its design, prevents the need of an over-dimensioned heat pump.

### SUMMARY

The objective of the invention is achieved by means of the initially defined spray dryer arrangement further comprising the following features:
a bypass conduit provided in the secondary liquid circuit for bypassing the second heat exchanger, and a controllable valve for controlling a flow of secondary liquid into the bypass conduit and to the second heat exchanger respectively,
a temperature sensor for measuring the temperature of the secondary liquid in the secondary liquid circuit, and
a control unit configured to control the controllable valve on basis of input from the temperature sensor, and configured to thereby regulate the temperature of the secondary liquid in the secondary circuit to be within a predetermined temperature range.

If the temperature of the liquid in the secondary liquid circuit is below a predetermined temperature, the control unit is configured to control the valve so as to increase the flow of secondary liquid through the second heat exchanger and reduce flow through the bypass conduit. If the temperature is too high, the control unit is configured to control the valve so as to decrease the flow of secondary liquid through the second heat exchanger and increase the flow through the bypass conduit. Thereby, a stabilization of the spray dryer arrangement, and of the preconditions for the operation of the heat pump, is achieved. The aim is to obtain a constant set temperature of the secondary liquid at the evaporator. Accordingly, the control unit is configured to control the distribution of the secondary liquid to the second heat exchanger and the bypass conduit as a response to the measured temperature in the circuit in order to achieve a set temperature value.

According to an embodiment, the secondary liquid circuit comprises a third heat exchanger configured for heat exchange between the secondary liquid and air introduced into the dehumidifier device through the dehumidifier device air inlet. Preferably, the spray dryer arrangement comprises a temperature sensor for measuring the temperature of the air leaving the third heat exchanger, and the control unit is configured to control the flow of secondary liquid to and through the third heat exchanger on basis of input from that temperature sensor in order to control the temperature of the air leaving the third heat exchanger.

According to an embodiment,
the dehumidifier element comprises an air inlet and an air outlet for passing air through a part of the dehumidifier element for a heating of the latter, and
the primary liquid circuit comprises a fourth heat exchanger configured for heat exchange between the primary liquid and air that is introduced into dehumidifier element via said dehumidifier air inlet. According to one embodiment, the dehumidifier is a desiccant dehumidifier, and said part is a part of the dehumidifier element that for the moment is not used for drying air passing through the dehumidifier. In other words, said heating is for regeneration of the dehumidifier element.

The objective of the invention is also achieved by means of a method of controlling a spray dryer arrangement, said spray dryer arrangement comprising
a spray dryer device comprising an air inlet and an air outlet, and an inlet for introduction of material to be dried and an outlet for removal of material that has been dried in the spray dryer device,
a heat pump comprising a closed circuit in which a heat transferring medium is circulated, wherein the closed circuit comprises a compressor, an expansion valve device, an evaporator and a condenser,
a dehumidifier device comprising an air inlet and an air outlet, and a dehumidifier element for dehumidification of air introduced through the air inlet and removed through the air outlet,
a primary liquid circuit, which is connected to the closed circuit of the heat pump via heat-exchange through the condenser and which comprises a first heat exchanger configured for heat exchange between the primary liquid and air which is to be introduced into the spray drier device through the spray dryer device inlet,
a secondary liquid circuit, which is connected to the closed circuit of the heat pump via heat exchange through the evaporator, and which comprises a second heat exchanger configured for heat exchange between the secondary liquid and air removed from the spray dryer device via the spray dryer device air outlet, and
   a bypass conduit provided in the secondary liquid circuit for bypassing the second heat exchanger,
   wherein said method comprises the steps of
measuring the temperature of the secondary liquid in the secondary liquid circuit, and
controlling a flow of secondary liquid into the bypass conduit (66) and to the second heat exchanger respectively on basis of the measured temperature, and thereby regulating the temperature of the secondary liquid in the secondary circuit to be within a predetermined temperature range.

According to an embodiment, the method also comprises the step of:
exchanging heat between the secondary liquid and air introduced into the dehumidifier device through the dehumidifier device air inlet.

According to an embodiment, the method also comprises the further steps of:
passing air through a part of the dehumidifier element for a heating of the latter, and,
exchanging heat between the primary liquid and air that is to be passed through said part of the dehumidifier element.

According to one embodiment, the flow rate of the primary liquid through the primary circuit is kept constant and the flow rate of the secondary liquid through the secondary circuit is kept constant during operation of the disclosed spray dryer arrangement.

Further features are presented in the following detailed description of embodiments.

### BRIEF DESCRIPTION OF THE DRAWINGS

FIG. 1 is a schematic representation of a heat pump circuit, a primary liquid circuit and a secondary liquid circuit according to the invention, indicating where heat exchangers between primary liquid circuit and air and between secondary liquid circuit and air are provided, and

FIG. 2 is a schematic representation of a spray dryer arrangement according to the invention, also indicating where heat exchangers between primary liquid circuit and air and between secondary liquid circuit and air are provided in the arrangement.

FIG. 3 is a schematic representation corresponding to that of FIG. 2 of a second embodiment.

### DETAILED DESCRIPTION

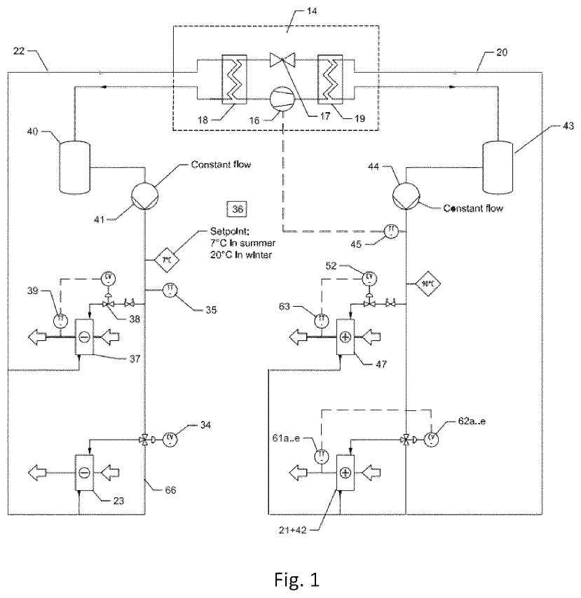

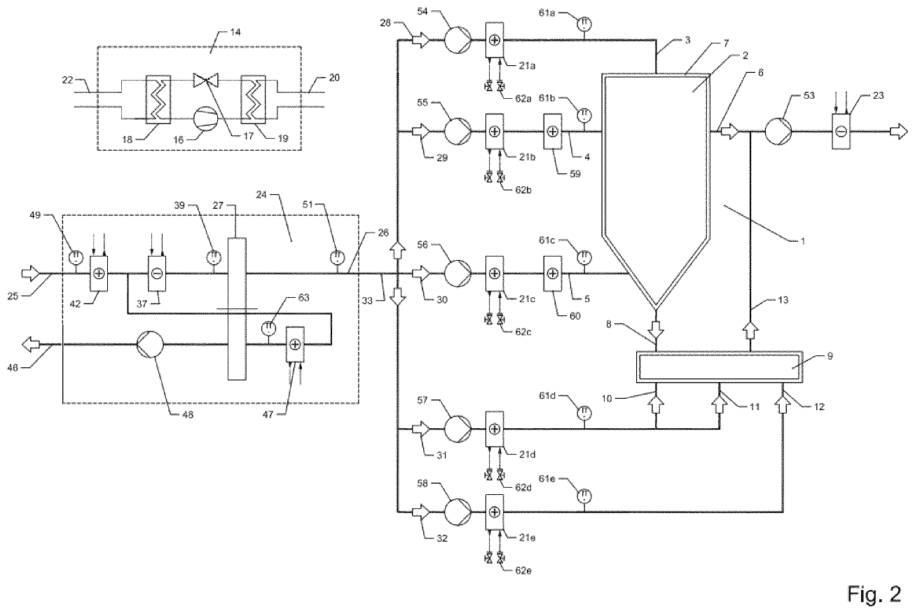

FIGS. 1 and 2 show alternative representations of one and the same spray dryer arrangement, though FIG. 1 is more focused on showing the heat pump and liquid circuits, while FIG. 2 is more focused on showing how air, to be heated or cooled by means of the heat pump, is flowing into and out of the respective components of the spray dryer arrangement.

With reference to FIGS. 1 and 2, the spray dryer arrangement comprises a spray dryer device 1 comprising a spray dryer 2 having air inlets 3, 4, 5 and an exhaust air outlet 6.

The spray dryer 2 also comprises an inlet 7 for introduction of material to be dried and an outlet 8 for removal of material that has been dried in the spray dryer 2. The spray dryer device 2 also comprises a fluid bed 9 configured to receive dried material from the outlet 8 of the spray dryer 2. The fluid bed 9 has air inlets 10, 11, 12 for introduction of air for further drying, and an outlet 13 for exhaust air from the fluid bed 9. The outlet 13 from the fluid bed 9 is connected to the outlet 6 of the spray dryer 2 such that exhaust air from the spray dryer 2 is mixed with exhaust air from the fluid bed 9. A fan 53 is provided downstream said outlets 6, 13.

The spray dryer arrangement further comprises a heat pump 14 comprising a closed circuit 15 in which a heat transferring medium is circulated, wherein the closed circuit 15 comprises a compressor 16, an expansion valve device 17, an evaporator 18 and a condenser 19.

A primary liquid circuit 20 (see FIG. 1 in particular) is connected to the closed circuit 15 of the heat pump 14 via heat-exchange through the condenser 19. The primary liquid circuit 20 comprises first heat exchangers 21a, 21b, 21c, 21d, 21e configured for heat exchange between the primary liquid and air which is to be introduced into the spray drier device 1 through the inlets 3, 4, 5 of the spray dryer 2 and the inlets 10, 11, 12 of the fluid bed 9.

A secondary liquid circuit 22 is connected to the closed circuit 15 of the heat pump via heat exchange through the evaporator 18, thereby forming a cold side of the heat pump 14. The secondary liquid circuit 22 comprises a second heat exchanger 23 configured for heat exchange between the secondary liquid and exhaust air removed from the spray dryer device 1 via the outlet 6 from the spray dryer 2 and the outlet 13 from the fluid bed 9.

In the embodiment shown, the primary liquid is water and the second liquid is water. Furthermore, the spray dryer arrangement comprises a dehumidifier device 24 comprising an air inlet 25 and an air outlet 26, and a dehumidifier element 27 for dehumidification of air introduced through the air inlet 25 and removed through the air outlet 26. The dry air removed from the outlet 26 of the dehumidifier device 24, after having passed the dehumidifier element 27, is conducted via branches 28, 29, 30, 31, 32 of an air conduction conduit 33 to the respective air inlets 3, 4, 5 of the spray dryer 2 and the respective air inlets 10, 11, 12 of the fluid bed 9. The above mentioned first heat exchangers 21a-21e are arranged in said branches 28-32, one in each branch. In each of said branches 28-32 there is provided a fan 54-58. In two of branches, branch 29 and branch 30, there is provided an electric heater 59, 60 for top-up heating of the air flowing in those branches.

The spray dryer arrangement further comprises a bypass conduit 66 provided in the secondary liquid circuit for bypassing the second heat exchanger, and a controllable valve 34 for controlling a flow of secondary liquid into the bypass conduit 66 and to the second heat exchanger 23 respectively

The spray dryer arrangement further comprises a temperature sensor 35 for measuring the temperature of the secondary liquid in the secondary liquid circuit 22, and a control unit 36 configured to control the controllable valve 34 on basis of input from the temperature sensor 35, and configured to thereby regulate the temperature of the secondary liquid in the secondary circuit 22 to a predetermined temperature. If the temperature of the liquid in the secondary liquid circuit is below a predetermined temperature, flow of secondary liquid through into the second heat exchanger 23 is increased and flow of secondary liquid through into the bypass conduit is decreased. If the temperature is too high, the opposite flow adjustment is performed. Thereby, a stabilization of the spray dryer arrangement, and of the preconditions for the operation of the heat pump 14, is achieved. The aim of the control of the flow through the second heat exchanger 23 and the bypass conduit 66 respectively is to obtain a constant set temperature of the secondary liquid at the evaporator 18.

It should also be mentioned that the flow rate of the primary liquid through the primary circuit 20 is kept constant and that the flow rate of the secondary liquid through the secondary circuit 22 is kept constant during operation of the disclosed spray dryer arrangement.

Furthermore, the secondary liquid circuit 22 comprises a third heat exchanger 37 configured for heat exchange between the secondary liquid and air introduced into the dehumidifier device 24 through the dehumidifier device air inlet 25. A control valve 38 for controlling the flow of secondary liquid to the third heat exchanger 37. A temperature sensor 39 for measuring the temperature of the air flowing towards the dehumidifier element 27 is provided between the third heat exchanger 37 and the dehumidifier element 27. The control unit 36 is connected to the temperature sensor 39 and to the control valve 38 and is configured to control the control valve 38 on basis of input from the temperature sensor 39 in order to obtain a predetermined temperature of the air conducted to the dehumidifier element 27.

There is also provided a temperature sensor 49 for measuring the ambient air temperature. The control unit 36 is configured to control the control valve 38 of the third heat exchanger 37 also on basis on input from the ambient air temperature sensor 49. If temperature sensor 49 indicates an ambient air temperature below a predetermined value, which indicates that the ambient is cold and, as a consequence thereof, dry, the control unit 36 closes the control valve 38 of the third heat exchanger 37 and turns off the action of the activity of the dehumidifier element 27. In this case, this means that the wheel 27 is kept rotating, but the regeneration, by heating thereof, is turned off.

The secondary liquid circuit 22 also comprises a cold water storage tank 40 and a pump 41.

The primary liquid circuit 20 comprises a fourth heat exchanger 42 configured for heat exchange between the primary liquid and air that is introduced into dehumidifier element 27 via said dehumidifier air inlet 25. The fourth heat exchanger 42 may be used for heating the air provided that the ambient temperature sensor indicates that the ambient air temperature is below a predetermined value. In this case that predetermined value is the same value as that for which the control unit 36 closes the control valve 38 of the third heat exchanger 37 and inactivates the dehumidifier element 27. The control unit 36 is also configured to control the flow of primary liquid through the fourth heat exchanger 42 on basis of input from the temperature sensor 39 provided between the third heat exchanger 37 and the dehumidifier element 27. In cases in which the third heat exchanger 37 is inactive (valve 38 closed), the temperature of the air passing through the dehumidifier 24 towards the spray dryer 1 is thus controlled, more precisely increased, by activation of the fourth heat exchanger 42, In the embodiment shown, the third heat exchanger 37 is located downstream the fourth heat exchanger 42 as seen in the flow direction of the air passing the third and fourth heat exchangers 37, 42.

The primary liquid circuit further comprises a fifth heat exchanger 47 configured for heat exchange with air that is used for regeneration of the dehumidifier element 27. In the exemplifying embodiment, the dehumidifier 24 is a desiccant dehumidifier and the dehumidifier element 27 is a wheel carrying the desiccant, wherein hot air introduced via the air inlet 25 of the dehumidifier device 24 is branched off from the air to be dried and is instead used for regenerating a part of the wheel that is for the moment not active. The dehumidifier 24 comprises a pump or fan 48 for pumping air that is branched of and used for regeneration of the dehumidifier element 27. There may preferably be provided a controllable valve (not shown) for controlling the flow of primary liquid through the fifth heat exchanger. An air moisture sensor 51 is provided downstream the dehumidifier element 27 for the purpose of determining the moisture content of air that has been dried in the dehumidifier 24. The control unit is configured to control the controllable valve 52, the rotational speed of the wheel 27 and the output of the fan/pump 48 on basis of input from the air moisture sensor 51. There is provided a separate outlet 46 for the air that has been used for regenerating the dehumidifier element 27.

The primary liquid further comprises a warm water storage tank 43 and a pump 44 for storing and pumping the primary liquid in the primary liquid circuit 20.

Further, the primary liquid circuit 20 comprises a temperature sensor 45 for measuring the temperature of the primary liquid. The control unit 36 is configured to control the compressor 16 of the heat pump 14 on basis of input from the temperature sensor 45.

Further components visible in the figures, but not described further in detail here are, in FIG. 1:
temperature sensors 61a-e for measuring air temperature downstream each of the first heat exchangers 21a-e, control valves 62a-e for controlling primary liquid flow through each of the first heat exchangers 21a-e on basis of input from the temperature sensors 61a-e;
temperature sensor 63 for measuring air temperature downstream the fifth heat exchanger 47, wherein the controllable valve 52 for controlling primary liquid flow through the fifth heat exchanger is controlled by the control unit 26 on basis of input from said temperature sensor;

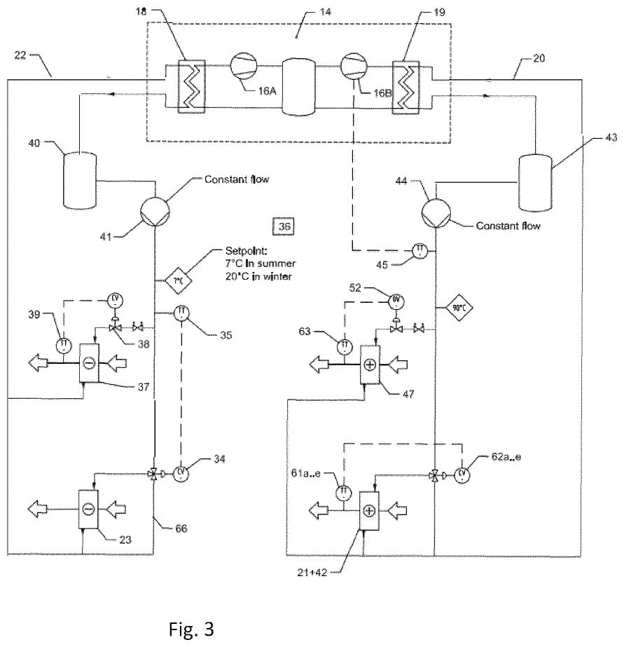

The alternative embodiment shown in FIG. 3 only differs from that shown in FIGS. 1 and 2 in that the compressor 16 comprises a low pressure compressor 16a and a high pressure compressor 16b. There is also provided an intercooler. The control unit 36 is thus configured to control both the low pressure compressor 16a and the high pressure compressor 16b.

1-6. (canceled)

7. A spray dryer arrangement comprising
a spray dryer device comprising an air inlet and an air outlet and an inlet for introduction of material to be dried and an outlet for removal of material that has been dried in the spray dryer device;
a heat pump comprising a closed circuit in which a heat transferring medium is circulated, wherein the closed circuit comprises a compressor, an expansion valve device, an evaporator and a condenser;
a dehumidifier device comprising an air inlet and an air outlet, and a dehumidifier element for dehumidification of air introduced through the air inlet and removed through the air outlet;
a primary liquid circuit, which is connected to the closed circuit of the heat pump via heat-exchange through the condenser and which comprises a first heat exchanger configured for heat exchange between the primary liquid and air which is to be introduced into the spray drier device through the spray dryer device inlet;
a secondary liquid circuit, which is connected to the closed circuit of the heat pump via heat exchange through the evaporator, and which comprises a second heat exchanger configured for heat exchange between the secondary liquid and air removed from the spray dryer device via the spray dryer device air outlet;
a bypass conduit provided in the secondary liquid circuit for bypassing the second heat exchanger, and a controllable valve for controlling a flow of secondary liquid into the bypass conduit and to the second heat exchanger, respectively;
a temperature sensor for measuring the temperature of the secondary liquid in the secondary liquid circuit; and
a control unit configured to control the controllable valve on basis of input from the temperature sensor, and configured to thereby regulate the temperature of the secondary liquid in the secondary circuit to be within a predetermined temperature range.

8. A spray dryer arrangement according to claim 7, wherein the secondary liquid circuit comprises a third heat exchanger configured for heat exchange between the secondary liquid and air introduced into the dehumidifier device through the dehumidifier device air inlet.

9. A spray dryer arrangement according to claim 7, wherein
the dehumidifier element comprises an air inlet and an air outlet for passing air through a part of the dehumidifier element for heating of the latter, and wherein
the primary liquid circuit comprises a fourth heat exchanger configured for heat exchange between the primary liquid and air that is introduced into dehumidifier element via said dehumidifier air inlet.

10. A method of controlling a spray dryer arrangement, the spray dryer arrangement comprising:
a spray dryer device comprising an air inlet and an air outlet, and an inlet for introduction of material to be dried and an outlet for removal of material that has been dried in the spray dryer device;
a heat pump comprising a closed circuit in which a heat transferring medium is circulated, wherein the closed circuit comprises a compressor, an expansion valve device, an evaporator and a condenser;
a dehumidifier device comprising an air inlet and an air outlet, and a dehumidifier element for dehumidification of air introduced through the air inlet and removed through the air outlet;
a primary liquid circuit, which is connected to the closed circuit of the heat pump via heat-exchange through the condenser and which comprises a first heat exchanger configured for heat exchange between the primary liquid and air which is to be introduced into the spray drier device through the spray dryer device inlet; and
a secondary liquid circuit, which is connected to the closed circuit of the heat pump via heat exchange through the evaporator, and which comprises a second heat exchanger configured for heat exchange between the secondary liquid and air removed from the spray dryer device via the spray dryer device air outlet, and a bypass conduit provided in the secondary liquid circuit for bypassing the second heat exchanger,
the method comprising the steps of:
measuring the temperature of the secondary liquid in the secondary liquid circuit; and
controlling a flow of secondary liquid into the bypass conduit and to the second heat exchanger, respectively, on basis of the measured temperature, and thereby regulating the temperature of the secondary liquid in the secondary circuit to be within a predetermined temperature range.

11. A method according to claim 10, further comprising the step of:
exchanging heat between the secondary liquid and air introduced into the dehumidifier device through the dehumidifier device air inlet.

12. A method according to claim 10, further comprising the steps of:
passing air through a part of the dehumidifier element for a heating of the latter; and
exchanging heat between the primary liquid and air that is to be passed through the part of the dehumidifier element.
